(19) United States
(12) Patent Application Publication
(10) Pub. No.: US 2022/0207933 A1
(43) Pub. Date: Jun. 30, 2022

(54) CENTRAL CONTROLLER AND MODULAR DEVICE

(71) Applicants: Jaswinder Kaur, Edmonton (CA); Amarinder Singh, Edmonton (CA)

(72) Inventors: Jaswinder Kaur, Edmonton (CA); Amarinder Singh, Edmonton (CA)

(21) Appl. No.: 17/139,038

(22) Filed: Dec. 31, 2020

(51) Int. Cl. G07C 5/08; G07C 5/00; B60R 16/023

(52) U.S. Cl. CPC G07C 5/0808; B60R 16/0234; G07C 5/006

(57) ABSTRACT

A central controller and modular device is provided, a central controller and modular device comprising one or more internal components from the group consisting of a data converter, a central controller, an engine performance controller, and a module replacement controller and a plurality of connection ports and connection lines along an exterior of the central controller and modular device wherein the connection ports and connection lines from the group consisting of one or more power connection ports and ground connection ports for powering one or more of the internal components, one or more data communication ports, data communication lines and engine output ports.

### FIELD OF THE INVENTION

The present disclosure relates to a central controller and modular device, specifically a device which can communicate with vehicle components and systems for performance, diagnostics and maintenance.

### BACKGROUND

W.O. Pub. No. 2012/038,723 A1 (Keates)—discloses a vehicle diagnostics port adaptor. Shortcomings include an inability to bypass existing vehicle modules, an inability to activate vehicle switches and gauges and an inability to wirelessly diagnose/monitor/control/operate their vehicle/machine remotely.

D.E. Pub. No. 10 2014 014 179 A1 (Kimmich)—discloses a method for guided remote diagnosis of a motor vehicle. Shortcomings include an inability to bypass existing vehicle modules, an inability to activate vehicle switches and gauges and an inability to plug into the vehicle through digital and/or data communication wires and vehicles power system.

U.S. Pub. No. 2013/0246135 A1 (Wang)—discloses a system, device and method of remote vehicle diagnostics-based service. Shortcomings include an inability to activate vehicle switches and gauges and an inability to plug into the vehicle through digital and/or data communication wires and vehicles power system.

U.S. Pat. No. 9,483,884 B2 (Chen et al.)—discloses a remote vehicle diagnostic system which utilizes a smart phone as a centralized communication hub between a vehicle and several remote resources. Shortcomings include an inability to bypass existing vehicle modules, an inability to activate vehicle switches and gauges and an inability to plug into the vehicle through digital and/or data communication wires and vehicles power system.

U.S. Pat. No. 9,466,155 B2 (Miljkovic et al.)—discloses a system to view automobile diagnostic information. Shortcomings include an inability to activate vehicle switches and gauges and an inability to plug into the vehicle through digital and/or data communication wires and vehicles power system.

U.S. Pat. No. 7,620,484 B1 (Chen)—discloses vehicle diagnostic systems and methods. Shortcomings include an inability to bypass existing vehicle modules, an inability to activate vehicle switches and gauges and an inability to wirelessly diagnose/monitor/control/operate their vehicle/machine remotely.

U.S. Pat. No. 7,142,962 B1 (Pflieger et al.)—discloses a system and method for wireless diagnosis, elimination of a defect, for a servicing or for preparing a servicing of a motor vehicle. Shortcomings include an inability to bypass existing vehicle modules, an inability to activate vehicle switches and gauges, an inability to wirelessly diagnose/monitor/control/operate their vehicle/machine remotely. and an inability to plug into the vehicle through digital and/or data communication wires and vehicles power system.

U.S. Pat. No. 6,925,368 B2 (Funkhouser et al.)—discloses a vehicle monitoring and maintenance device capable of being connected to a diagnostic port of a vehicle. Shortcomings include an inability to bypass existing vehicle modules, an inability to activate vehicle switches and gauges and an inability to wirelessly diagnose/monitor/control/operate their vehicle/machine remotely.

U.S. Pat. No. 6,529,808 B1 (Diem)—discloses a method and system for analyzing an on-board vehicle computer system. Shortcomings include an inability to bypass existing vehicle modules, an inability to activate vehicle switches and gauges and an inability to wirelessly diagnose/monitor/control/operate their vehicle/machine remotely.

U.S. Pat. No. 8,190,322 B2 (Lin et al.)—discloses a system and method for providing autonomous and remote vehicle maintenance and repair. Shortcomings include an inability to bypass existing vehicle modules, an inability to activate vehicle switches, an inability to wirelessly diagnose/monitor/control/operate their vehicle/machine remotely. and gauges and an inability to plug into the vehicle through digital and/or data communication wires and vehicles power system.

All references cited above are incorporated herein.

There is a need for a central controller and modular device that can be employed for troubleshooting and diagnosing fault, can be plus into a vehicle/machine through one or more of digital communication wires, data communication wire and the vehicle's/machine's power system, can bypass an existing module and turn the module into manual, can wirelessly diagnose/monitor/control/operate their vehicle/machine remotely, can activate vehicle switches and gauges and can receive digital communication signals and data communication signals.

### BRIEF SUMMARY

It is the object of the present invention to provide a central controller and modular device. A central controller and modular device comprising one or more internal components from the group consisting of a data converter, a central controller, an engine performance controller, and a module replacement controller and a plurality of connection ports and connection lines along an exterior of the central controller and modular device wherein the connection ports and connection lines from the group consisting of one or more power connection ports and ground connection ports for powering one or more of the internal components, one or more data communication ports, data communication lines and engine output ports.

In accordance with an embodiment of the invention, the central controller and modular device further comprises a wireless monitoring component.

In accordance with an embodiment of the invention, the group of connection ports and connection lines further comprises wireless transceivers.

In accordance with an embodiment of the invention, the group of connection ports and connection lines further comprises multiplex output ports.

In accordance with an embodiment of the invention, the group of connection ports and connection lines further comprises injector output ports.

In accordance with an embodiment of the invention, the group of connection ports and connection lines further comprises one or more CAN high ports and one or more CAN low ports.

In accordance with an embodiment of the invention, the central controller further comprises a switch option.

### BRIEF DESCRIPTION OF THE SEVERAL VIEWS OF THE DRAWINGS

To easily identify the discussion of any particular element or act, the most significant digit or digits in a reference number refer to the FIGURE number in which that element is first introduced.

FIG. 1 illustrates a system view 100 in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The central controller and modular device may be employed to preform one or more of the following functions. It can be used for all vehicles and engines (automobiles, heavy trucks, light trucks, trains, airplanes) and any other machinery by simply plugging it into the original plugs or by connecting to the data communication lines, vehicle power supply, any other necessary wires or other components. or you can also run, operate any vehicles, automotive, heavy truck, light trucks, trains, airplanes, any machinery.

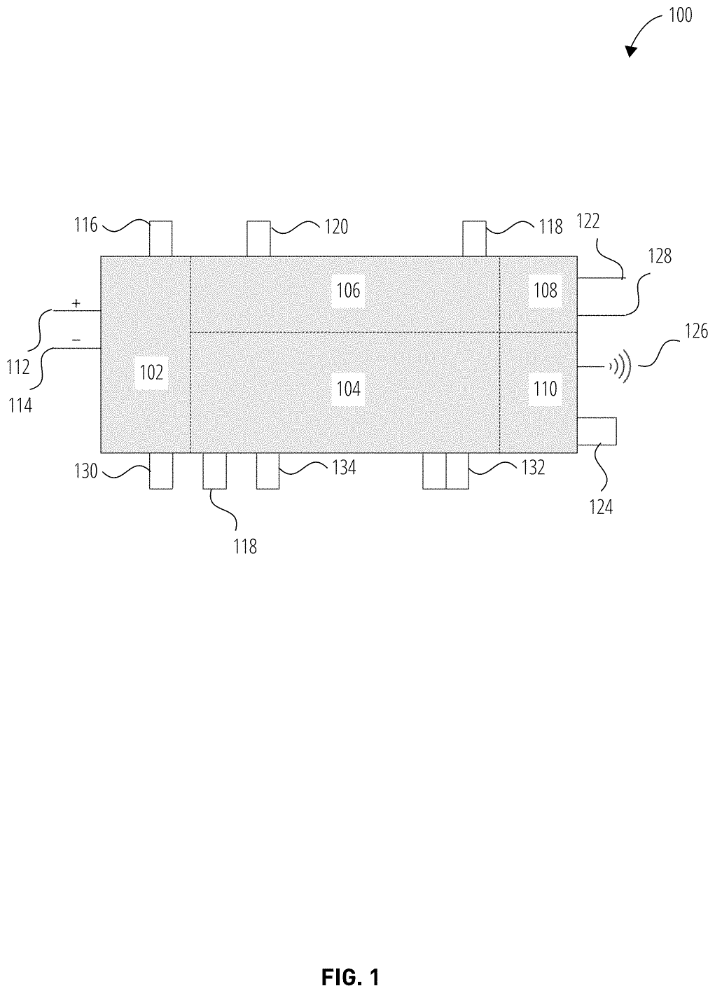

FIG. 1 depicts a system view 100 of the central controller and modular device in accordance with one embodiment. The central controller and modular device is shown comprising a data converter 102, central controller 104, engine performance controller 106, module replacement controller 108 and wireless monitoring 110 as internal components. Along the exterior of the central controller and modular device is a plurality of connection ports and lines, such as but not limited to, one or more power connection ports 112 and ground connection ports 114 for powering the central controller and modular device and all associated components, one or more data communication ports 118, one or more data communication lines 124, one or more multiplex output ports 134, one or more injector output ports 120, one or more engine output ports 132, one or more wireless transceivers 126, and one or more CAN high ports 122 and CAN low ports 128.

The central controller 104 is employed to manage output according to data communication and/or multiplex data from switches and other inputs and controls. The ports connected to the central controller 104 in FIG. 1 include a data communication port 118, a multiplex output port 134 and two engine output ports 132. In some embodiments, engine output port 132 is input/output for an engine sensor. In some embodiments, engine output port 132 is input/output for a solenoid. All of the outputs and data communication lines 124 can also be plugged into the original vehicle connectors or can be spliced/connected to the wiring. In some embodiments, the data communication ports 118 are a CAN bus, a UART or other data communication ports 118 known in the art. In some embodiments, the multiplex data is obtained from switches. In some embodiments, one or more engine output ports 132 connect to an engine fan, engine brakes, throttle, or any other engine components known in the art. The central controller and modular device also converts diesel/gas engine vehicle/machinery to fully electrical motor/vehicle, and in some embodiments, convert a fully electric vehicle to mechanical gas/diesel vehicle/engine.

The central controller 104 can control or operate any function in any vehicle/machinery in which it is coupled to. The operator of a certain vehicle or machinery operates using multiple switches, sensors, solenoids (air, hydro, fuel, electric), motors (engines, electric motors etc.), transmission and many more components all controlled by modules. The central controller 104 can replace all of the modules/controllers that control these components by plugging into the original plug(s) or splice into a data bus communication lines, ignition, power, and ground, or any other wires necessary. There are many different modules/controllers that control the vehicle/machine instead of having multiple modules/controllers, you can connect the central controller and modular device and get rid of the other modules/controllers, so the system has one module controlling everything in the vehicle. The operator will be able to increase or decrease the functions or change them according to their necessities. The central controller and modular device can also be used as a diagnostic tool to locate problems. Another function of this is that most operators of newer heavy trucks, light trucks, cars or any other machinery, don't like the newer engines and prefer older engines that are more reliable or vice versa. A problem exists such that it is very hard to make the older engines work with the newer electronic systems or newer engines with older vehicles. The central controller and modular device can be plugged in or connected through the data bus lines and it will become compatible and work with the newer systems all the gauges and all other required components, and the electronic system will have no problems. All electronic functions that should′ve been working with the original engine will work and can have more options. Likewise, with the transmissions, many people like to swap out the automatic transmission to the manual or the manual to automatic. In order to make all the electronic components to work you just connect the central controller and modular device and everything functions similar the original components and can modify functionality as needed. The central controller 104 can also control mechanical engines according to the user's preferences.

Currently, all combustion engines come with the emission treatment system most commonly known as the after treatment (DPF/DOC/SRC/DEF). It is most commonly seen in diesel powered vehicles/machinery. Many owners/operators don't like the emission system because it is known to cause many problems and it is very costly to repair. With the central controller 104 you can simply plug it in the original module or controller plug/splice into wires/connect to the sensors/any other electronic emission part it will bypass the entire emission system and this will allow the operator/owner to remove the emission system to avoid any future problems. This can also be used to diagnose the emission system. This can also run the original equipment manufacturer (OEM) emission system as its factory specs and environmental protection agency (EPA) regulations. The central controller and modular device may be employed for diagnostics for the emission system.

In some embodiment, the central controller and modular device may be employed to bypass one or more diesel particulate filter (DPF), selective catalytic reduction (SCR) and diesel exhaust fluid (DEF) on a variety of different vehicles, such as but not limited to, Mack MP8 and MP10 2011-2013 trucks, VOLVO D13 and D16 2011-2013 US10 and VOLVE D13 and D16 2017-2020 US17+ trucks, Hino trucks, Isuzu trucks and Detroit Diesel engines. Since most vehicles have a delicate and intricate electronics system, incorrect programming and connection can result in serious engine and transmission failure. This can often be attributed due to poor programming, effecting engine and transmission performance. The central controller and modular device does not require any programming and does not make changes to the engine control module of the vehicle or any other module.

In some embodiments, a switch option is present that allows the user you to switch between the device and the original system. For example, the switch option may allow the user to switch between this device (disabling the DPF/SCR/DEF/UREA system) and the original system which return to the factory state. In other embodiments, the switch option may be applied to one or more systems and modules such as, but not limited to, an engine control module, a common powertrain controller, a motor control module and an electronic control unit.

In some circumstances, truck dealers and shops may refuse to work on vehicles that have removed one or more components of their after treatment (DPF/SCR/DEF) system. With the switch option emulator, the user can simply turn off the central controller and modular device by turning off the switch, allowing the vehicle to return to a factory stock functionality and necessary repairs from the dealers or shops. Once the repairs are completed, the switch may be switch on allowing for the central controller and modular device to be powered on. In some circumstance, problems may arise in the DPF sensors even if the DPF filters are clean. The switch option may be employed to eliminate this error while a vehicle is brought in for maintenance or repairs and turned off the switch once completed.

The data converter 102 function allows the central controller and modular device to translate input from the data communication ports 118, such as the data communication A port 116 and data communication B port 130 from FIG. 1. In some embodiments, the user may convert data from the data communication A port 116 to data communication B port 130. In some embodiments, the user may convert data from data communication B port 130 to data communication A port 116. For example, newer vehicles have a different protocol, data communication A port 116, than the older engines, data communication B port 130, and this allows them to communicate with each other.

With the data converter 102 you can convert one data bus communication to the other one. For example, a newer system in a truck is not going to communicate with an older engines data communication system or a newer engine in an older vehicle, the data converter 102 will allow them to communicate with each other. This also works the same way as the other modules/controllers. It will convert the bitrate, protocol type, serial port data into other formats for example if a vehicle system runs on the UART protocol and the engine that has been replaced runs on CAN bus, the central controller and modular device will allow them to communicate with each other, another example, works if a system runs on as specific data bus on specific speed, specific bitrate, specific protocol with this device you change in to any speed, bitrate and protocol as per needed.

The engine performance controller 106 function allows the central controller and modular device to monitor engine performance and adjust component operation based on real time performance analysis based on input from the data communication port 118 and the injector output port 120 from FIG. 1. In some embodiments, the engine performance controller 106 has predetermined performance metrics programmed into the central controller and modular device. With the engine performance controller 106 you can control any kind of engine, such as diesel or gas, according to your preferences in any type of vehicle/machine. This will allow the operator to control the engine according to their own requirements. It can also upgrade the stock engine's performance to make the vehicle/machine capable of performing in racing, off-roading or any other activity that requires more power. The operator can control the injectors, fuel pump, throttle, and any other sensor/solenoid. It can also be connected via the central controller 104 or you can connect it directly to the engine/sensor wiring.

The wireless monitoring 110 allows the user to wirelessly diagnose/monitor/control/operate their vehicle/machine engine from our software with their smartphone, tablet, computer, laptop or any other similar device. For example, starting the vehicle remotely from anywhere in the world or setting restrictions on speed, rpm and many more function remotely as well. I

With the module replacement controller 108 you can replace any module or controller in the vehicle/machine. You can plug this in the original plug or splice in the data bus communication lines/wires or anywhere else on the electronic system. The module replacement controller 108 is capable of continuously sending certain data messages continuously or the same way as the original module and you can also modify the messages according to your needs. The module replacement controller 108 can also be used as a diagnostic tool.

In some embodiments, the central controller and modular device further comprises a transceiver that is capable of generating data signals continuously for any automotive/heavy duty vehicle/machinery and engine transmission. The transceiver can be configured to continuously generate any type of data signal which can be connected directly to the data lines/wires of the system or in the original plug. Also, this can basically send CAN bus signals or any other data signals continuously by copying the previously existing signals or any other signals. You can also remove or add data signals.

The central controller and modular device can work on every vehicle on road or off-road, heavy trucks, light trucks, automobiles, engines, transmissions or any vehicle that has (and runs on) communication wires that carries the digital and/or communication data. The way it works you can plug it into the system through digital and/or data communication wires and vehicles power system and it can be employed to perform the same function. You can also employ the central controller and modular device as a tool to troubleshoot modules or diagnosis by plugging it into the digital and/or data communication lines 124 or wires and power system and by removing the module that you want to replace. The central controller and modular device can be employed to bypass the existing modules, for example if you have a door module and you have an active fault code for that module you can plug in the central controller and modular device and unplug the original module. This will eliminate codes this will tell you if there's a problem with the door module. Alternatively, the module can be left on the vehicle permanently and employ a manual switch for operation such that no door module codes are required, and system becomes fully manual without the need of a module. This may be applied to any other module in the vehicle.

The central controller and modular device may also be employed if you are switching a new engine or automatic transmission, that use data or digital communication system, with an older engine or manual transmission or the other way around. In one embodiment, if a newer vehicle uses a different protocol than the older one, the central controller and modular device will translate from the new data or digital communication to older data or digital communication. In another embodiment, if an older mechanical engine is to be reposed into a newer truck, the central controller and modular device can be plugged/connected into the gauges/multiplex data/communication and allows all of the data and digital communications to work without any other adjustments or modifications.

The central controller and modular device may be applied the same way if you put a newer engine into an older vehicle. The central controller and modular device can be installed on completely mechanical engines, that are being installed into a newer vehicle, with sensors, solenoids and other electronic components. The central controller and modular device converts the signals from the sensors and converts them into data communication signals (for example: CAN bus, UART etc.) so the newer vehicle will use this can bus, universal asynchronous receiver-transmitter (UART), signal to make all gauges, switches, transmission, etc. will function properly without any modifications similar to the factory state with the original OEM engine.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A central controller and modular device comprising:
one or more internal components from the group consisting of a data converter, a central controller, an engine performance controller, and a module replacement controller; and
a plurality of connection ports and connection lines along an exterior of said central controller and modular device wherein said connection ports and connection lines from the group consisting of one or more power connection ports and ground connection ports for powering one or more of said internal components, one or more data communication ports, data communication lines and engine output ports.

2. The central controller and modular device of claim 1, wherein said central controller and modular device further comprises a wireless monitoring component.

3. The central controller and modular device of claim 1, wherein said group of connection ports and connection lines further comprises wireless transceivers.

4. The central controller and modular device of claim 1, wherein said group of connection ports and connection lines further comprises multiplex output ports.

5. The central controller and modular device of claim 1, wherein said group of connection ports and connection lines further comprises injector output ports.

6. The central controller and modular device of claim 1, wherein said group of connection ports and connection lines further comprises one or more CAN high ports and one or more CAN low ports.

7. The central controller and modular device of claim 1, wherein said central controller further comprises a switch option.
